(19) United States
(12) Patent Application Publication
(10) Pub. No.: US 2016/0086115 A1
(43) Pub. Date: Mar. 24, 2016

(54) Performance Management by Indication

(71) Applicant: IMS Health Incorporated, Danbury, CT (US)

(72) Inventors: Francesco Pistone, Milano (IT); Silvia Trovesi, Milano (IT); Francesca Rampi, Milano (IT); Marta Casiraghi, Legnano-Milano (IT)

(21) Appl. No.: 14/489,886

(22) Filed: Sep. 18, 2014

(51) Int. Cl. G06Q 10/06; G06Q 50/22

(52) U.S. Cl. CPC G06Q 10/0639; G06Q 50/22

(57) ABSTRACT

A computer-implemented method for providing a user with product consumption data stored at one or more databases includes receiving a transaction message indicating pharmaceutical product consumption for a particular pharmaceutical product from a prescribing facility and receiving a prescribing message with prescription data for the particular pharmaceutical product from one or more prescribers. The prescription data for the particular pharmaceutical product is translated into an updated database instruction configured to interface with a database and modify a record in the database based on the received pharmaceutical product consumption data. Related records within the database are identified and a multicomponent behavioral record that reflects the updated database instruction is generated. An average dosage for the particular product is calculate and based on the calculated dosage and a projected number of patients a multicomponent consumption record for an indication of the particular product is generated.

### BACKGROUND

The understanding of the market potential, distribution of prescribers and the monitoring of the evolution of the market shares for each indication of a particular pharmaceutical drug is important to optimize the performance and timing of market launches.

### SUMMARY

In one aspect, a computer-implemented method for providing a user with product consumption data at one or more databases includes receiving a transaction message indicating pharmaceutical product consumption for a particular pharmaceutical product from a prescribing facility, receiving a prescribing message with prescription data for the particular pharmaceutical product from one or more prescribers, translating, based on the received pharmaceutical product consumption data, the prescription data for the particular pharmaceutical product into an updated database instruction configured to interface with a database and modify a record in the database, identifying related records within the database, generating, based on identifying related records within the database, a multicomponent behavioral record that reflects the updated database instruction, calculating, based on the multicomponent behavioral record, an average dosage for the particular pharmaceutical product, and generating, based on the calculated average dosage and a projected number of patients, a multicomponent product consumption record for an indication of the particular pharmaceutical product, wherein the multicomponent product consumption record includes a consumption record for the indication of the particular pharmaceutical product and a number of patients treated for the indication of the particular pharmaceutical product.

In another aspect, a request to access the product consumption record for one or more particular pharmaceutical products stored within the database is received, the database is accessed for the requested record and the accessed product consumption records for the one or more particular pharmaceutical products is presented to a user.

In yet another aspect, the accessed product consumption records for the one or more particular pharmaceutical products is presented to a user as a PowerPoint document. The received transaction message indicating pharmaceutical product consumption for a particular pharmaceutical product from a prescribing facility includes receiving a data file, a stream of data or a datagram.

In another aspect, generating a multicomponent product consumption record for an indication of a particular pharmaceutical product includes generating a multicomponent product consumption record that reflects an estimated patient consumption for a treatment pathology of the particular pharmaceutical product.

In yet another aspect, a product consumption split is determined where a particular pharmaceutical product is identified to have one or more indications. In yet another aspect, the product consumption split for each of the one or more indications of the particular pharmaceutical product is determined at a national geographic level or regional geographic level. The granularity of the geographic level depends on the received product consumption data and prescription data.

In another aspect, the product consumption split for each of the one or more indications of the particular pharmaceutical product is determined based on patient characteristics. The patient characteristics include patient gender, patient age, and patient line of therapy.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example of an analytical infrastructure system implemented in a computing system 100.

FIG. 2 illustrates an example user interface of user interaction with a webpage application of a performance management tool.

FIG. 3 illustrates the three key dimensions defined in a report for the performance by indication for a particular pharmaceutical product.

FIG. 4 is a flow chart of an example process for calculating the consumption split of pathologies.

FIG. 5 is a flow chart of an example process for generating a multicomponent product consumption record.

### DETAILED DESCRIPTION

This disclosure generally describes computer-implemented methods, software, and systems for determining a product consumption for each of the one or more indications, or treatment pathologies of a particular pharmaceutical drug. The computer-implemented methods, systems and software provide reports on the number of patients and/or market share of consumption on the total market share for the particular pharmaceutical product. The results report is supplied to a client and may include the consumption split by indication for the particular pharmaceutical product based on geography and frequency of sampling of the data.

Optimizing the timing of launching a pharmaceutical product and optimizing the performance of the launch is very important in today's current competitive pharmaceutical market. Understanding the market potential of a particular drug, the distribution of prescribers and the evolution of the market shares for each of the treatment pathologies for the drug are factors that influence the understanding of the market place and are essential in optimizing the timing of a launch for a product. Other information, such as, potential patients for each of the treatment pathologies, the competitors for each indication, the ability to size the market, and trace the evolution of market shares for the different treatment pathologies is very valuable in developing pharmaceutical product launch strategies.

Typically, the consumption data information that is collected and reported for a particular pharmaceutical product spans across the consumptions levels and does not identity the number of patients per indication or treatment pathology. On the other hand, the present disclosure provides reports to customers that include precise data on the number of patients treated and on the consumption data for each indication or treatment pathology for a particular pharmaceutical product.

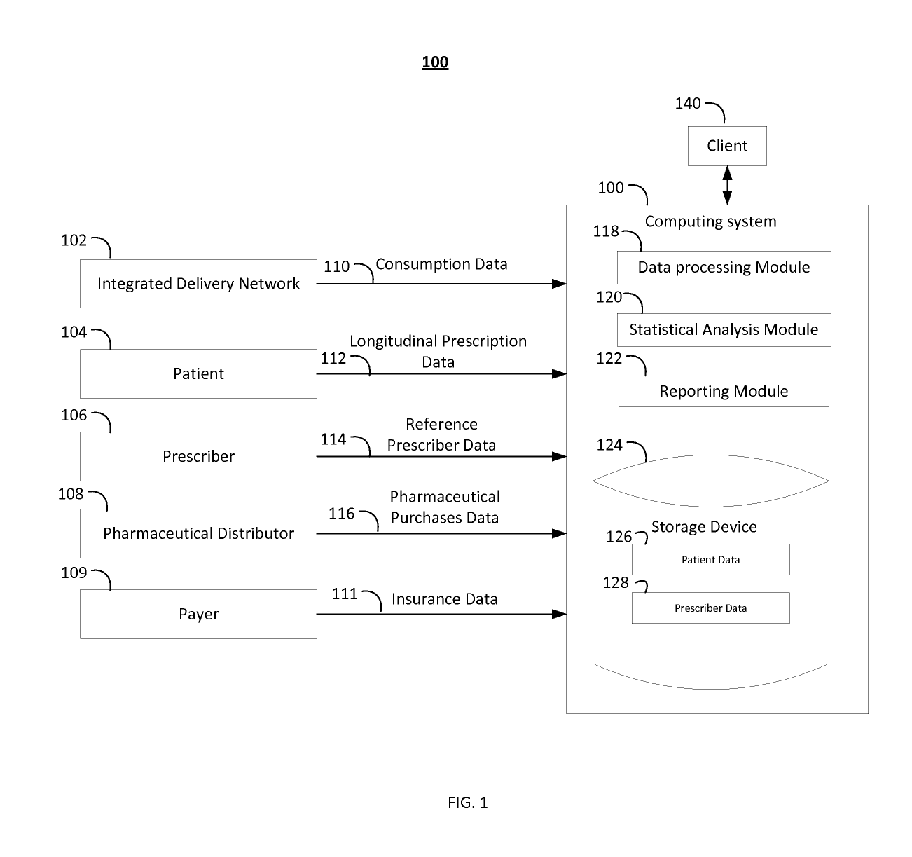

FIG. 1 illustrates an example analytical infrastructure system implemented in a computing system 100. The computing system may be implemented as a data processing apparatus that is capable of providing the functionality discussed herein, and may include any appropriate combination of processors, memory, and other hardware and software that can receive appropriate medical data and process the data as discussed below. At a high-level, the illustrated example computing system 100 receives various data from sources that are participants in the healthcare system. The sources may include IDNs 102, patient system 104, prescriber system 106, pharmaceutical distributors 108, and payer system 109. The data may include consumption data 110, longitudinal patient data 112, reference prescriber data 114, pharmaceutical purchases data 116, and payers insurance data 111.

FIG. 1 illustrates the process by which an analytical infrastructure is able to integrate data received about the consumption of a pharmaceutical product. It is important to understand that the system may be configured to preserve patient privacy, and will not store nominative data in an aggregated database but only de-identified data. Nominative data for an individual can be compared to the relevant aggregated data, but this may be achieved by using aggregated values in the individual patient application, not by keeping nominative records for multiple patients in a single database. Also, the integration of data from sources other than the user and their medical professionals may be achieved on a de-identified basis except in the instance that the individual gives permission to use their identity information (name, location, gender and age) for the purpose of providing them with their information from another source, such as pharmaceutical purchase data 116 from pharmacies.

The consumption data 110 may include data regarding pharmaceutical drugs used by patients within an IDN. The consumption data 110 may be received directly from one or more IDNs 102 and represent data reflecting all pharmaceutical products used within the one or more IDNs 102, including information about the prescription for the product, the type of prescription used to obtain the product and the payment method used to purchase the product. As noted previously, this information may be sanitized and aggregated to protect patient privacy. Though FIG. 1 shows the consumption data 110 being provided directly from the one or more IDNs 102 to the computing system 100, the prescription data 110 may be collected by one or more other intermediate systems and then provided to the computing system 100. If intermediate systems are used, the aggregation and sanitization of the retail prescription data 110 may potentially be performed by the intermediate systems.

The longitudinal patient data 112 may include sanitized retail patient-level data for the one or more patient systems 104. For example, the longitudinal patient data 112 may include information about retail pharmacy-sourced prescription insurance claims, retail pharmaceutical scripts, and/or patient profile data. Longitudinal patient data 112 includes information about aspects of care for the one or more patient systems 104. Though FIG. 1 illustrates the longitudinal patient data 112 as being received by the computing system 100 directly from one or more patient systems 104, the longitudinal patient data 112 may be collected by one or more other systems and then provided to the computing system 100 in a manner analogous to the similar approach discussed for consumption data 110. Moreover, the longitudinal patient data 112 may not originate from the one or more patient systems 104, but may rather be provided by one or more prescribers/physicians with whom the patient interacts, insurance companies to which a patient submits insurance claims, and/or retailers at which a patient purchases a pharmaceutical product. In some implementations the longitudinal patient data 112 may originate from one or more pharmaceutical companies.

The reference prescriber data 114 may include data obtained through primary market research. The primary market research may include face to face interviews with physicians and prescribers. The primary market research may target specialist within different fields of medicine. The physicians may be a selected group of physicians, the physicians may be selected from hospitals, IDNs, or any other treatment facility that is determined within a census of treatment facilities. The physicians may be physicians that have volunteered to be involved in the market research. The physicians may part take in one or more essential and exhaustive questionnaires. The questionnaires may be conducted through web interviews or may be conducted through in person interviews. The questionnaires may be conducted on a quarterly cycle or any other suitable time period. The questionnaires may be designed to include detailed questions about the prescribing habits of the participating physicians. The information gathered from the primary market research from the physicians may include patient and patient dosages information. The information received through the questionnaires may include the number of patients treated for each indication of a particular pharmaceutical product, the number of patients treated with each biologics agent for each indication, and the patient split by market dynamics for each indication of a particular pharmaceutical product. The one or more physicians or prescribers that participate in the primary market research may fill out a patient diary for a subset of his/her patients each week. The patient diary for each patient may include the patient's therapeutic history. For example, the patient diary may include the patient classification, the number of administrations per month, the dosage per administration and the product package dispensed. Though FIG. 1 illustrates the reference prescriber data 114 as being received by the computing system 100 directly from one or more prescriber systems 106, the reference prescriber data 114 may be collected by one or more other systems and then provided to the computing system 100 in a manner analogous to the similar approach discussed for retail consumption data 110. Moreover, the reference prescriber data 114 may not originate from the one or more prescriber systems 106, but rather be created and/or maintained by one or more other entities (e.g., government agencies or professional medical organizations) that track information about the prescribing behavior of prescribers 106.

The pharmaceutical purchase data 116 may include information about pharmaceutical purchases made from distributors 108 (e.g., pharmaceutical wholesalers or manufacturers). For example, the pharmaceutical purchase data 116 may include information about the outlet from which a pharmaceutical product is purchased, the type of pharmaceutical product purchased, the location of both the purchaser and seller of the pharmaceutical product, when the purchase was conducted, and/or the amount of a pharmaceutical product that was purchased. Though FIG. 1 illustrates the pharmaceutical purchase data 116 as being received by the computing system 100 directly from one or more distributors 108, the pharmaceutical purchase data 116 may be collected by one or more other systems and then provided to the computing system 100 in a manner analogous to the similar approach discussed for retail prescription data 110. Moreover, the pharmaceutical purchase data 116 may not originate from the one or more distributors 108, but rather be provided by the purchaser of the pharmaceutical product (e.g., a retail outlet).

The insurance data 111 may include information about insurance companies covering the cost of prescriptions. For example, the insurance data 111 may include information about how much of a prescription's cost was covered by the insurance company or by Medicaid. Though FIG. 1 illustrates the insurance data 111 as being received by the computing system 100 directly from one or more payer system 109, the insurance data 111 may be collected by one or more other systems and then provided to the computing system 100.

The various types of data just discussed, which may include consumption data 110, longitudinal prescription data 112, reference prescriber data 114, pharmaceutical purchases data 116, and insurance data 111, are received by computing system 100 in order to derive conclusions based on the data. As noted previously, by the time the data is received by computing system 100, it should have been sanitized so that the data does not include private or confidential information that computing system 100 should not able to access.

For illustrative purposes, computing system 100 will be described as including a data processing module 118, a statistical analysis module 120, a reporting module 122, and a storage device 124. However, the computing system 100 may be any computing platform capable of performing the described functions. The computing system 100 may include one or more servers that may include hardware, software, or a combination of both for performing the described functions. Moreover, the data processing module 118, the statistical analysis module 120, and the reporting module 122 may be implemented together or separately in hardware and/or software. Though the data processing module 118, the statistical analysis module 120, and the reporting module 122 will be described as each carrying out certain functionality, the described functionality of each of these modules may be performed by one or more other modules in conjunction with or in place of the described module.

The data processing module 118 receives and processes one or more of consumption data 110, longitudinal patient data 112, reference prescriber data 114, pharmaceutical purchase data 116, and insurance data 111. In processing the received data, the data processing module 118 may filter and/or mine the consumption data 110, longitudinal patient data 112, reference prescriber data 114, pharmaceutical purchase data 116, and insurance data for specific information. The data processing module 118 may filter and/or mine the received consumption data 110, longitudinal patient data 112, reference prescriber data 114, pharmaceutical purchase data 116, and insurance data 111 for specific pharmaceuticals. Thus, any received consumption data 110, longitudinal patient data 112, reference prescriber data 114, pharmaceutical purchase data 116, and insurance data 111 that regards pharmaceutical products that are not classified as being associated with a tracked compound or prescription may be disregarded. For example, the received data may be processed by data processing module 118 so as to track use of a specific antibiotic, or of antibiotics in general.

After processing the received consumption data 110, longitudinal patient data 112, reference prescriber data 114, pharmaceutical purchase data 116, and insurance data 111, the data processing module 118 aggregates the processed data into patient data 126 and prescriber data 128. These groups of data may be stored in storage device 124.

In other implementations, the data processing module 118 may simply sort and store, in storage device 124, processed prescription data 110, longitudinal patient data 112, reference prescriber data 114, pharmaceutical purchase data 116 and insurance data, the data processing module 118 for later use by other modules.

For each patient system 104, the patient data 126 may include any information related to the prescription and/or sale of one or more types of pharmaceutical products. Patient data 126 may include the quantity of each type of pharmaceutical product the patient has purchased, cumulative days' supply of a pharmaceutical product the patient should still have, cumulative dosage of a pharmaceutical product, medication possession ratio, the number and/or name of doctors from which the patient has received scripts, the number and/or name of retail outlets from which the patient has purchased pharmaceutical products, and/or information regarding the payment method(s) used by the patient when purchasing pharmaceutical products (e.g., cash or insurance). In some implementations, patient data 126 may include demographic information, for example, patient age, patient gender, patient geographical location. In some implementations, patient data 126 may include the line of therapy information for a particular pharmaceutical drug. For example, if the drug was the first product prescribed to the patient, or the second product prescribed to the patient.

The prescriber data 128 received from the prescriber system 106, may include any information related to prescriptions written by an identified prescriber for one or more types of pharmaceutical products and the patients to whom the prescriptions were written. Prescriber data 128 may include the quantity of one or more types of pharmaceutical products for which the prescriber has written a prescription, the percentage of prescriptions for one or more types of pharmaceutical products written by a prescriber in relation to the total number prescriptions written by the prescriber, the percentage of prescriptions for one or more types of pharmaceutical products that are paid for with cash, and/or the number of patients for whom the prescriber has written a prescription for one or more types of pharmaceutical products and who currently have a supply of the one or more types of pharmaceutical products that exceeds a threshold.

The statistical analysis module 120 uses a statistical model to integrate the patient data 126 and the prescriber data 128. The statistical model is used to combine the tracking of the consumption of a particular pharmaceutical product and the tracking of patient data to estimate the overall consumption and patient levels by indication or treatment pathology for a particular pharmaceutical product.

The reporting module 122 prepares reports based on the data collected by the computing system 100. The reports prepared by the reporting module 122 may include consumption records for a particular drug by indication. The consumption records may include the consumption of the drug based on the one or more treatment pathologies of the drug and also the estimated number of patients treated for each treatment pathology. The report generated may include the market share of patients for each indication of the pharmaceutical drug selected and the market share of consumption for the pharmaceutical drug selected.

Additionally, in some implementations, the reports generated may be either dynamic or static. The reporting module 122 may generate a report that includes data presented in one or more static formats (e.g., a chart, a graph, or a table) without providing any mechanism for altering the format and/or manipulating the data presented in the report. In such an implementation, the data presentation is generated and saved without incorporating functionality to update the data presentation. In some implementations, the reporting module 122 provides a static report in a PDF, spreadsheet, or XML format. Such a format generally provides an understanding of the reporting module 122 as textual data or a visualization, but other forms of presenting conclusions such as audio, video, or an animation are not excluded as potential results from reporting module 122. The reporting module 122 may provide a static report in a PowerPoint format.

Additionally or alternatively, the reporting module 122 may generate a report that includes controls allowing a user to alter and/or manipulate the report itself interactively. For example, the reporting system may provide a dynamic report in the form of an HTML document that itself includes controls for filtering, manipulating, and/or ordering the data displayed in the report. Moreover, a dynamic report may include the capability of switching between numerous visual representations of the information included in the dynamic report. In some implementations, a dynamic report may provide direct access as selected by a user to some or all of the patient data 126 and prescriber data 128 prepared by the data processing module 118 and/or the statistical analysis module 120, as opposed to allowing access to only data and/or ratings included in the report itself.

One or more clients 140 may interface with the computing system 100 to request and receive reports created by the reporting system. In some implementations, the one or more clients 140 may include a web browser that provides Internet-based access to the computing system 100. Through the web browser, a user of a client 140 (e.g., a wholesaler, a retail outlet, or a prescriber) may request a static or dynamic report from the reporting system as discussed above.

There may be any number of clients 140 associated with, or external to, the example computing system 100. While the illustrated example computing system 100 is shown in communication with one client 140, alternative implementations of the example computing system 100 may communicate with any number of clients 140 suitable to the purposes of the example computing system 100. Further, the term “client” and “user” may be used interchangeably as appropriate without departing from the scope of this disclosure. Moreover, while the client 140 is described in terms of being used by a single user, this disclosure contemplates that many users may share the use of one computer, or that one user may use multiple computers.

The illustrated client 140 is intended to encompass computing devices such as a desktop computer, laptop/notebook computer, wireless data port, smartphone, personal digital assistant (PDA), tablet computing device, one or more processors within these devices, or any other suitable processing device. For example, the client 140 may include a computer that includes an input device, such as a keypad, touch screen, or other device that can accept user information, and an output device that conveys information associated with the operation of the computing system 100. The input device may be used by client 140 to provide instructions to computing system 100 that computing system 100 can execute to provide information requested by client 140 from the various data that computing system 100 receives. The analytical infrastructure may be supported on a webpage application that a client may use to view the data received by the computing system at the analytical infrastructure.

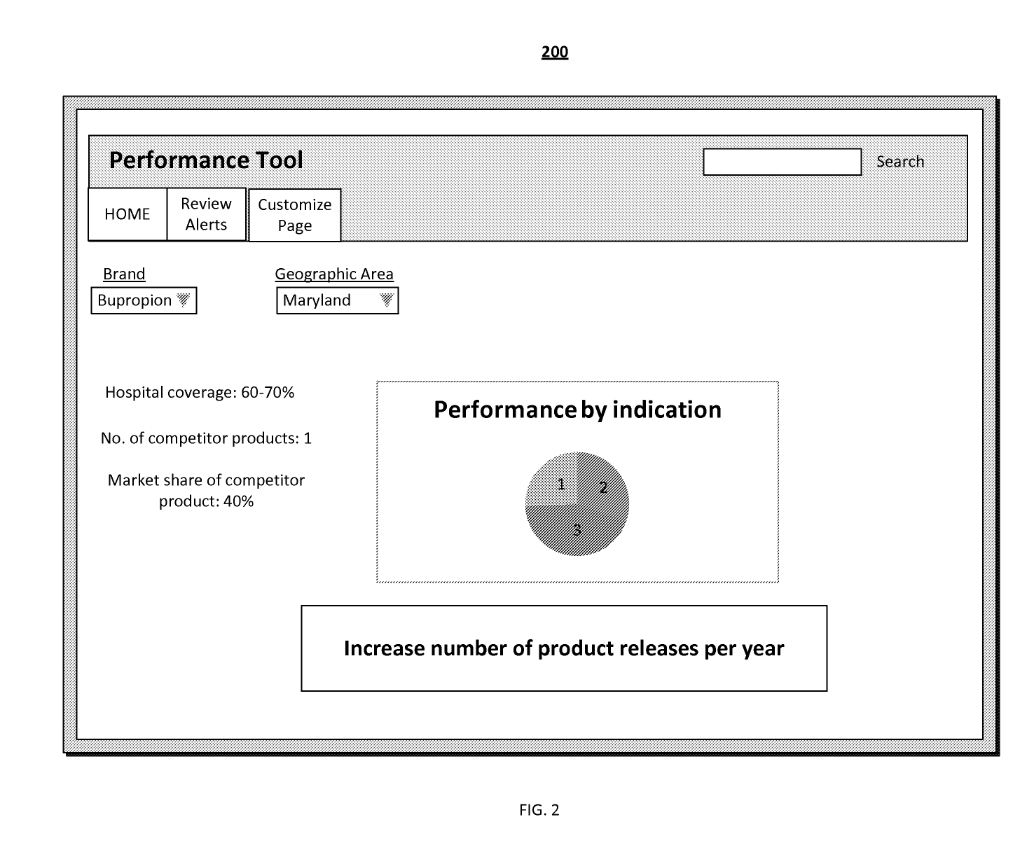

FIG. 2 illustrates an example user interface for user interaction with an application of a consumption by indication offering. A user may be a client 140 that accesses the web-application to the computing system 100. The user may be a pharmaceutical sales representative at a pharmaceutical company that is interested in the market data for a particular pharmaceutical product. In some examples, the user maybe an internal IMS consultant. Interface 200 may be displayed when a user logs into a secure connection with the consumption by indication application offering. The user may log into the application by providing a user specific user name and password. The webpage may be specific to individual users of the application, that is, the webpage generated is specific to the user. In some implementations, the user may have the option to customize the information displayed on the web page. In these implementations, the webpage may include a “Customize Page” tab displayed on the home page.

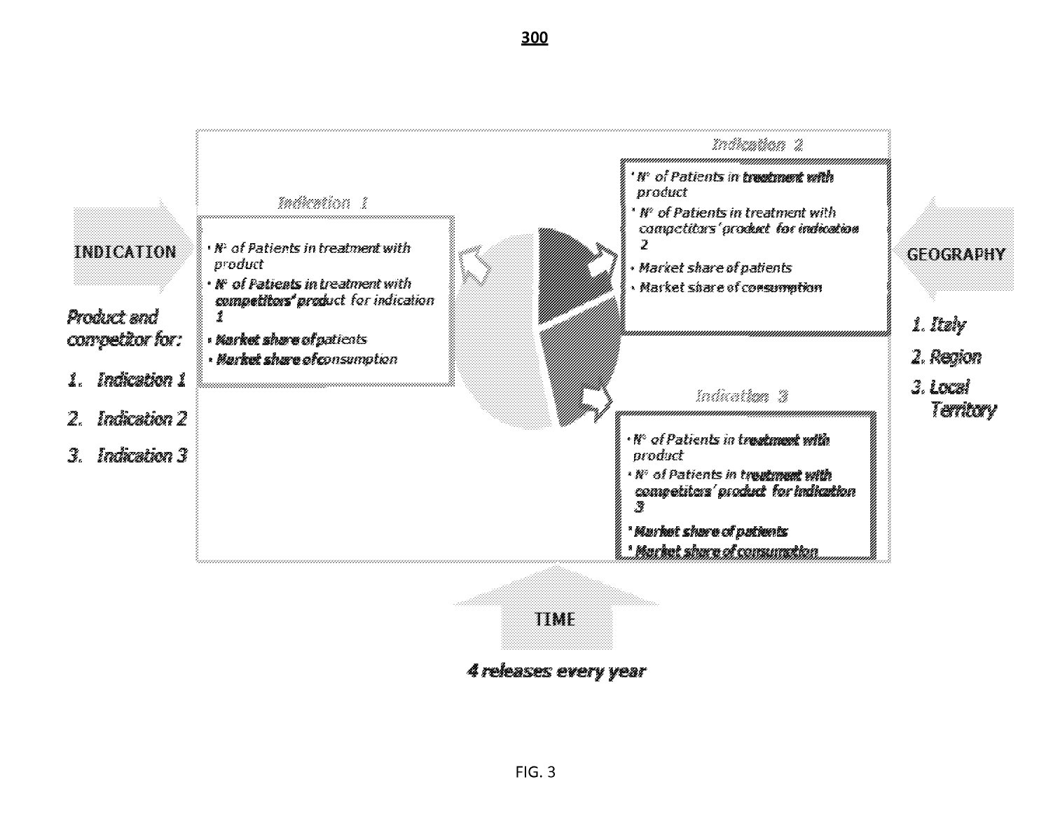

The user interface may display report information based on a selected pharmaceutical product and a selected geographical area. As illustrated in FIG. 3, the user interface may include a drop down select tab that allows a user to select a particular pharmaceutical product, for example, Januvia. The user interface may also include a drop down select tab that allows a user to select a particular geographic location of interest, for example Maryland. The user interface may list the number of competitor products for the selected product. In some implementations, the name of the competitor product or products may be listed. The user interface may display the consumption data by indication in a chart. For example, the results may be displayed in a pie chart, as illustrated in FIG. 2. The user may have the ability to select the method used to display the consumption data. The user may select the consumption data be displayed in a bar graph, a line graph, or any other suitable type of graph. The user interface may include details on the data set that was used to generate the consumption by indication data. For the example illustrated in FIG. 2, the consumption data covers 60-70% of consumption data in the specified geographical area. In some implementations, the computing systems at the analytical infrastructure may not have sufficient data to produce consumption data for a particular geographic location. In these implementations, the computing systems may generate an error message that displays to the user that the data set is insufficient. The computing systems may use a data set for a larger geographical area if the geographical area selected by the user is small and does not have sufficient consumption data. The report information may list the number of any competitor products of the selected pharmaceutical drug. The report information may also include the market share of the listed competitor products.

FIG. 3 illustrates the three key dimensions defined in a report for the performance by indication for a particular pharmaceutical product. The computing systems at the analytical infrastructure may generate reports based on the user selected pharmaceutical product. The generated report can be utilized by a user to understand the market dynamics of a particular pharmaceutical product. For example, the generated report may include information on the market, band and competitors performance. The generated reports may include the number of patients treated for each indication of a particular pharmaceutical product. The results may also be expressed as a share of consumption of a total market. For each generated result, the data may be detailed along three key dimensions, that is, indications, geography, and frequency.

The results may include the list of the indications for the selected pharmaceutical product. For each indication of the particular pharmaceutical product, the results may indicate the number of patients in treatment with the product, the number of patients in treatment with the competitor product, the market share of patients and the market share of consumption for the indication for the particular pharmaceutical product. For the results may be based on a particular geographic location. Consumption data may be collected for a large geographic area and based on the quality of the data set the results can be provided on a granular basis. For example, consumption data may be collected on a nationwide scale and results can be displayed for a particular country, state or city. The consumption data may be collected and used to generate consumption by indication reports each quarter of the year. In some implementations, the results may be presented to the user in a Microsoft Excel format. In some implementations, the results may be presented to the user in a PowerPoint document.

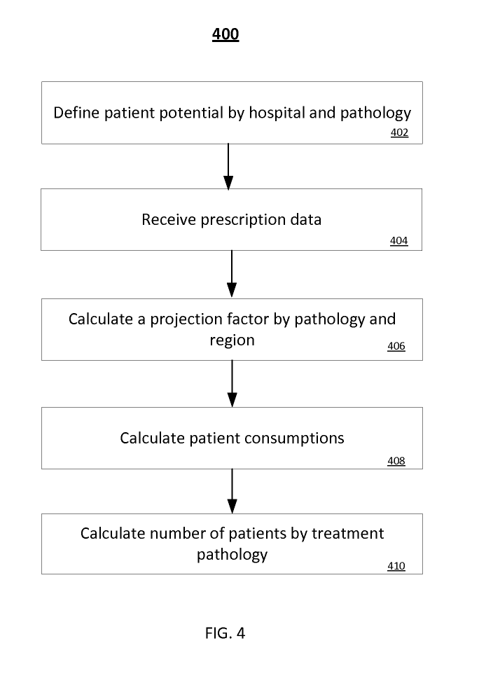

FIG. 4 is a flow chart of a process 400 for calculating the number of patients by consumption split of treatment pathologies. The computing systems at the analytical infrastructure define patient potential by hospital and pathology (402). The universe of hospitals or treatment centers is generated and is referred to as the census. The census may include a selection of hospitals, Integrated Delivery Networks (IDNs), or treatment centers that cover more than 70 percent of consumption of a particular pharmaceutical product. The census may be defined by the consumption data received at the computing systems 100. The census may identify the universe of patients for any indication or treatment pathology of a particular pharmaceutical product. The census may be defined for a particular geographical location. For example, the census may be defined by the hospitals, Integrated Delivery Networks (IDNs), or treatment centers within a state or a zip code. In another example, the census may be a global census.

The computing systems at the analytical infrastructure receive prescription data (404). The prescription data may be received by conducting primary market research. The data collected through the primary market research may be collected and submitted to the computing systems at the analytical infrastructure on a time schedule. For example, the data may be collected and submitted every month, every two weeks, or any other suitable time period. The primary market research may include face to face interviews with physicians and prescribers. The primary market research may target specialist within different fields of medicine. The physicians may be a selected group of physicians, the physicians may be selected from hospitals, IDNs, or any other treatment facility that is determined within a census of treatment facilities. The physicians may be physicians that have volunteered to be involved in the market research. The physicians may part take in one or more essential and exhaustive questionnaires. The questionnaires may be conducted through web interviews or may be conducted through in person interviews. The questionnaires may be conducted on a quarterly cycle or any other suitable time period. The questionnaires may be designed to include detailed questions about the prescribing habits of the participating physicians. The information gathered from the primary market research from the physicians may include patient and patient dosages information. The information received through the questionnaires may include the number of patients treated for each indication of a particular pharmaceutical product, the number of patients treated with each biologics agent for each indication, and the patient split by market dynamics for each indication of a particular pharmaceutical product. The one or more physicians or prescribers that participate in the primary market research may fill out a patient diary for a subset of his/her patients each week. The patient diary for each patient may include the patient's therapeutic history. For example, the patient diary may include the patient classification, the number of administrations per month, the dosage per administration and the product package dispensed.

The computing systems at the analytical infrastructure define a statistical model. The statistical model may integrate the consumption data received from the hospitals in the census and the patient data received from prescribers from hospitals and treatment centers within the census. The consumption data received from the hospitals, Integrated Delivery Networks (IDNs), and treatment centers may include the total consumption for the pharmaceutical products used in the hospital or treatment center. The statistical model may link the hospital consumption data and patient pathology data to the hospital dimension and hospital structural variables, hospital wards of interest, hospital consumption by wards, and total consumption. In some implementations, the computing systems at the analytical infrastructure using a regression model to calculate patient estimation for all hospitals in the census.

The computing systems at the analytical infrastructure calculate a projection factor by treatment pathology and geographical region (406). The projection factor by treatment pathology and region is calculated based on the proportion between the sample of patients and the universe of patients. The projection factor is calculated by the equation below:

$${COEXP}_{Ki} = \frac{{\sum }_{m} {\sum }_{k} {\sum }_{i} {Patient}_{ki}}{{\sum }_{sm} {\sum }_{k} {\sum }_{i} {Patient}_{ki}}$$

The computing systems at the analytical infrastructure calculate patient consumptions (408). The calculated projection factor is used to calculate a projected number of patients based on the patient data collected from the primary market research. The patient data collected from the primary market research is collected from one or more prescribers within the census hospitals, IDNs, or treatment centers. The data may be collected based on questionnaires that are conducted on a quarterly basis. In some implementations, the questionnaires may be conducted on a monthly basis. The projected patient is collected by the equation below:

$${Proj\_PATIENT}_{nKi} = {\sum }_{s} {COEXP}_{ki} * {Patient}_{snki}$$

The average dosage by pathology and product is calculated using the data collected through the primary market research. The average dosage may be estimated through data obtained through the patient diaries collected by the physicians or prescribers in the census hospitals. The patient diaries may include for each patient treated by a physician or prescriber the patient classification, the number of administration per month, the dosage per administration, and the product package dispensed. The average dosage by pathology and product is calculated by the equation below, where n is the pharmaceutical product, p is the number of patient diaries, and k is the treatment pathology:

Dosageₙₖ=Average(Dosageₙₖₚ)

The estimated consumption is then calculated by multiplying the average dosage by treatment pathology and product by the projected patients:

Estimated_Consumptionₙₖₗ=Dosageₙₖ·Proj_PATIENT_{nKl}

The computing systems at the analytical infrastructure calculate the number of patients by treatment pathology (410). The estimated consumption is compared with hospital consumption data. Hospital consumption data may be received by the computing systems at the analytical infrastructure from one or more hospitals and treatment centers. The hospital consumption data may include information for specific wards. For example, the hospital consumption data may include information from the derma, gastro, rheuma and therapeutic areas.

RHA Consumptionₙᵢ

The regional split by treatment pathology is defined and the regional split by treatment pathology and product is applied to the hospital consumption as seen below:

$${Consumption}_{nki} = RHA {Consumption}_{ni} * \frac{{Estimated\_Consumption}_{nki}}{{\sum }_{k} {Estimated\_Consumption}_{nki}}$$

The consumption split by treatment pathology is calculated by dividing the calculated total consumption by the calculated dosage as seen in the equation below:

$${Patient}_{nki} = \frac{{Consumption}_{nki}}{{Dosage}_{nk}}$$

Some pharmaceutical products may be used for the treatment of one or more pathologies. The calculated consumption split by treatment pathologies specifies the number of patients that are treated for each of the treatment pathologies for a particular pharmaceutical product. The patient consumption by treatment pathology is calculated based on a particular geographical location. The census population of hospitals may be determined based on a particular zip code, city or state. The quality and stability of the results generated may be ensured by automated routines and additional timely controls and thorough examination of the consistency of the expanded data with the real data of hospital consumption (RHA) for each product, at local level. An estimate of the standard error as a measure of the quality of the data may be provided with the result report through the user interface of the consumption by split offering. The estimate of the standard error depends on the variability of the split data, the number of sampled hospitals and the consumption covered by the sample over the total.

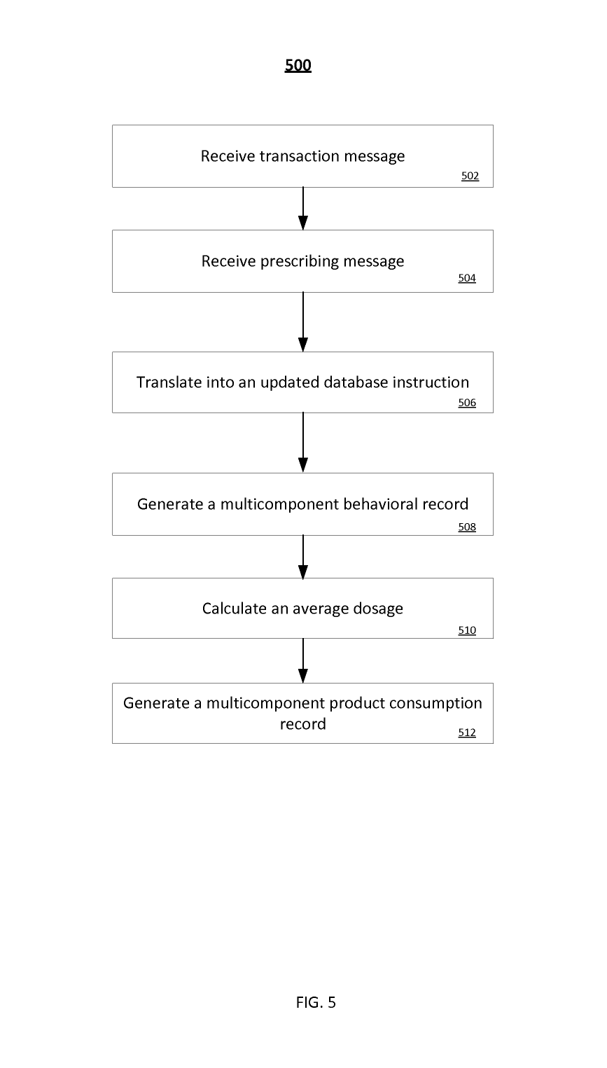

FIG. 5 is a flow chart of a process 500 for generating a multicomponent product consumption record. The computing systems at the analytical infrastructure receive a transaction message indicating pharmaceutical product consumption for a particular pharmaceutical product from a prescribing facility (502). The transaction message received may be a data file, a stream of data, or a datagram. The pharmaceutical product consumption data may be received from the computing systems of one or more hospitals, IDNs, treatment facilities, or prescribing facilities. The pharmaceutical product consumption data received may include worldwide, national, and regional epidemiological data. The data may include consumption data that is specific to wards of a hospital and may include consumption data for the overall market. The consumption data may include the consumption data for one or more pharmaceutical products. In some implementations, the consumption data may include the consumption data for a particular pharmaceutical product and may also include the consumption data for any competitor products of the particular pharmaceutical product.

The computing systems at the analytical infrastructure receive a prescribing message with prescription data for the particular pharmaceutical product from one or more prescribers (504). The prescribing message received may be a data file, a stream of data, or a datagram. In some implementations, the prescribing message may be received from the computing systems of one or more prescribers. The prescription data may be gathered by conducting primary market research. The data collected through the primary market research may be collected and submitted to the computing systems at the analytical infrastructure on a time schedule. For example, the data may be collected and submitted every month, every two weeks, or any other suitable time period. The primary market research may include face to face interviews with physicians and prescribers. The primary market research may target specialists within different fields of medicine. The physicians may be a selected group of physicians, the physicians may be selected from hospitals, IDNs, or any other treatment facility that is determined within a census of treatment facilities. The physicians may be physicians that have volunteered to be involved in the market research. The physicians may part take in one or more essential and exhaustive questionnaires. The questionnaires may be conducted through web interviews or may be conducted through in person interviews. The questionnaires may be conducted on a quarterly cycle or any other suitable time period. The questionnaires may be designed to include detailed questions about the prescribing habits of the participating physicians. The information gathered from the primary market research from the physicians may include patient and patient dosages information. The information received through the questionnaires may include the number of patients treated for each indication of a particular pharmaceutical product, the number of patients treated with each biologics agent for each indication, and the patient split by market dynamics for each indication of a particular pharmaceutical product. The one or more physicians or prescribers that participate in the primary market research may fill out a patient diary for a subset of his/her patients each week. The patient diary for each patient may include the patient's therapeutic history. For example, the patient diary may include the patient classification, the number of administrations per month, the dosage per administration and the product package dispensed.

The computing systems at the analytical infrastructure translate the prescription data for the particular pharmaceutical product into an updated database instruction configured to interface with a database and modify a record in the database, based on the received pharmaceutical product consumption data (506). The pharmaceutical product consumption data received may be stored in one or more databases at a server system. The received prescription data for the particular pharmaceutical product is then stored with the received consumption data for the same pharmaceutical product. The related consumption data and the related prescription data may be identified as related data records. In some implementations, the consumption data and prescription data for each pharmaceutical product may be stored in discrete databases at the computing systems of the analytical infrastructure. In other implementations, the consumption data and prescription data for the related pharmaceutical product may be tagged with identifiers and stored in the same database.

The computing systems at the analytical infrastructure generate a multicomponent behavioral record (508). The received consumption data and the received prescription data may be integrated using a statistical model to generate a combination of the two data sources. In some implementations, a regression model may be used to integrate the prescription data and the consumption data sources.

The computing systems at the analytical infrastructure calculate an average dosage for the particular pharmaceutical product based on the multicomponent behavioral record (510). The multicomponent behavioral record may include the received prescription data and the consumption data for the particular pharmaceutical product in a single record in a database. The computing systems at the analytical infrastructure may use the prescription data received to calculate and average dosage by treatment pathology. The prescription data may include information collected by prescribers though patient diaries. The patient diaries may include for each patient treated by a physician or prescriber the patient classification, the number of administration per month, the dosage per administration, and the product package dispensed. The patient diaries may include other patient characteristic information. For example, the patient diaries may include the gender and age of the patients. The patient diaries may also include the line of therapy information. The line of therapy may indicate whether the prescribed product is the first, second or third product tried by the patient. The average dosage by pathology and products is calculated by the equation below:

Dosageₙₖ=Average(Dosageₙₖₚ)

The computing systems at the analytical infrastructure generate a multicomponent product consumption record for an indication of the particular pharmaceutical product based on the calculated average dosage and a projected number of patients (512). The multicomponent consumption record may include the consumption record for each indication of the particular pharmaceutical product and the number of patients treated for the indication of the particular pharmaceutical product.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method for providing a user with product consumption data stored at one or more databases, the method comprising:
receiving a transaction message indicating pharmaceutical product consumption for a particular pharmaceutical product from a prescribing facility;
receiving a prescribing message with prescription data for the particular pharmaceutical product from one or more prescribers;
translating, based on the received pharmaceutical product consumption data, the prescription data for the particular pharmaceutical product into an updated database instruction configured to interface with a database and modify a record in the database;
identifying related records within the database;
generating, based on identifying related records within the database, a multicomponent behavioral record that reflects the updated database instruction;
calculating, based on the multicomponent behavioral record, an average dosage for the particular pharmaceutical product; and
generating, based on the calculated average dosage and a projected number of patients, a multicomponent product consumption record for an indication of the particular pharmaceutical product, wherein the multicomponent product consumption record includes a consumption record for the indication of the particular pharmaceutical product and a number of patients treated for the indication of the particular pharmaceutical product.

2. The computer-implemented method of claim 1 further comprising;
receiving a request to access the product consumption record for one or more particular pharmaceutical products stored within the database;
accessing the database for the requested record; and
presenting the accessed product consumption records for the one or more particular pharmaceutical products to a user.

3. The computer-implemented method of claim 2 wherein presenting the accessed product consumption records for the one or more particular pharmaceutical products to a user comprises presenting a PowerPoint document to the user.

4. The computer-implemented method of claim 1 wherein receiving a transaction message indicating pharmaceutical product consumption for a particular pharmaceutical product from a prescribing facility comprises receiving a data file, a stream of data or a datagram.

5. The computer-implemented method of claim 1 wherein generating a multicomponent product consumption record for an indication of a particular pharmaceutical product comprises generating a multicomponent product consumption record that reflects an estimated patient consumption for a treatment pathology of the particular pharmaceutical product.

6. The computer-implemented method of claim 1 wherein a product consumption split is determined where a particular pharmaceutical product is identified to have one or more indications.

7. The computer-implemented method of claim 6 wherein the product consumption split for each of the one or more indications of the particular pharmaceutical product is determined at a national geographic level or regional geographic level.

8. The computer-implemented method of claim 7 wherein the granularity of the geographic level depends on the received product consumption data and prescription data.

9. The computer-implemented method of claim 6 wherein the product consumption split for each of the one or more indications of the particular pharmaceutical product is determined based on patient characteristics.

10. The computer-implemented method of claim 9 wherein the patient characteristics includes patient gender, patient age, and patient line of therapy.

11. A system comprising:
one or more computers and one or more storage devices storing instructions that are operable, when executed by one or more computers, to cause the one or more computers to perform operations comprising:
receiving a transaction message indicating pharmaceutical product consumption for a particular pharmaceutical product from a prescribing facility;
receiving a prescribing message with prescription data for the particular pharmaceutical product from one or more prescribers;
translating, based on the received pharmaceutical product consumption data, the prescription data for the particular pharmaceutical product into an updated database instruction configured to interface with a database and modify a record in the database;
identifying related records within the database;
generating, based on identifying related records within the database, a multicomponent behavioral record that reflects the updated database instruction;
calculating, based on the multicomponent behavioral record, an average dosage for the particular pharmaceutical product; and
generating, based on the calculated average dosage and a projected number of patients, a multicomponent product consumption record for an indication of the particular pharmaceutical product, wherein the multicomponent product consumption record includes a consumption record for the indication of the particular pharmaceutical product and a number of patients treated for the indication of the particular pharmaceutical product.

12. The system of claim 11 further comprising;
receiving a request to access the product consumption record for one or more particular pharmaceutical products stored within the database;
accessing the database for the requested record; and
presenting the accessed product consumption records for the one or more particular pharmaceutical products to a user.

13. The system of claim 11 wherein receiving a transaction message indicating pharmaceutical product consumption for a particular pharmaceutical product from a prescribing facility comprises receiving a data file, a stream of data or a datagram.

14. The system of claim 11 wherein generating a multicomponent product consumption record for an indication of a particular pharmaceutical product comprises generating a multicomponent product consumption record that reflects an estimated patient consumption for a treatment pathology of the particular pharmaceutical product.

15. The system of claim 11 wherein a product consumption split is determined where a particular pharmaceutical product is identified to have one or more indications.

16. The system of claim 15 wherein the product consumption split for each of the one or more indications of the particular pharmaceutical product is determined at a national geographic level or regional geographic level.

17. The system of claim 16 wherein the granularity of the geographic level depends on the received product consumption data and prescription data.

18. The system of claim 15 wherein the product consumption split for each of the one or more indications of the particular pharmaceutical product is determined based on patient characteristics.

19. The system of claim 18 wherein the patient characteristics includes patient gender, patient age, and patient line of therapy.

20. A non-transitory computer-readable medium storing software comprising instructions executable by one or more which, upon such execution, cause the one or more computers to perform operations comprising:
receiving a transaction message indicating pharmaceutical product consumption for a particular pharmaceutical product from a prescribing facility;
receiving a prescribing message with prescription data for the particular pharmaceutical product from one or more prescribers;
translating, based on the received pharmaceutical product consumption data, the prescription data for the particular pharmaceutical product into an updated database instruction configured to interface with a database and modify a record in the database;
identifying related records within the database;
generating, based on identifying related records within the database, a multicomponent behavioral record that reflects the updated database instruction;
calculating, based on the multicomponent behavioral record, an average dosage for the particular pharmaceutical product; and
generating, based on the calculated average dosage and a projected number of patients, a multicomponent product consumption record for an indication of the particular pharmaceutical product, wherein the multicomponent product consumption record includes a consumption record for the indication of the particular pharmaceutical product and a number of patients treated for the indication of the particular pharmaceutical product.
